(19) United States
(12) Patent Application Publication
(10) Pub. No.: US 2017/0220741 A1
(43) Pub. Date: Aug. 3, 2017

(54) SYSTEM, METHOD, AND NON-TRANSITORY COMPUTER-READABLE STORAGE MEDIA FOR GENERATING DATA FOR USE IN COMPUTER SYSTEMS

(71) Applicant: Wal-Mart Stores, Inc., Bentonville, AR (US)

(72) Inventors: Justin Toupin, San Francisco, CA (US); Nathan Thomas Diepenbrock, Highlands Ranch, CO (US)

(21) Appl. No.: 15/009,436

(22) Filed: Jan. 28, 2016

(51) Int. Cl. G06F 19/00; G10L 15/22

(52) U.S. Cl. CPC G06F 19/322; G06F 19/325; G06F 19/3456; G10L 15/22; G10L 2015/223

(57) ABSTRACT

A networked computer system for generating pharmaceutical data for use by an interactive voice response (IVR) program application stored on the mobile computing device is described herein. The system includes a server computer programmed to receive an IVR request signal from a mobile computing device, access a list of drug information data records and select a drug information data record associated with a received drug ID, and retrieve drug information included in the selected drug information data record. The server computer generates an IVR audio file including the corresponding drug information and transmits an IVR operation data signal to the mobile computing device including the IVR audio file to cause the mobile computing device to execute an IVR program application being stored on the mobile computing device to broadcast an audio presentation of the corresponding drug information to a user via the mobile computing device.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE DISCLOSURE

U.S. Patent Classification Primary Class: 707 (DATA PROCESSING: DATABASE, DATA MINING, AND FILE MANAGEMENT OR DATA STRUCTURES). Art Unit: 2161.

The present invention relates to providing product information to a consumer, and more particularly, to systems, methods, and computer-readable storage media that monitor activities of pharmacy customers and generates data for use in operating an interactive voice response program via a mobile device.

### BACKGROUND

Many pharmacy consumers desire to obtain services related to their general heath and the pharmaceutical medications being prescribed to them remotely, e.g., on-line, through the Internet, or using a specially designed application or app on a personal computer or mobile device, such as a tablet or cell phone. In addition, pharmacy customers desire to have services that facilitate their adherence to medication schedules and improve general health monitoring.

At least some known web hosting systems include information associated with pharmaceutical drugs including treated illnesses and potential side effects. These known systems allow customers to search drug databases for the names of particular pharmaceutical drugs, select one or more drugs stored in the database, and display information related to the selected drugs. However, because of the increasing number of pharmaceutical drugs being made available to consumers and the amount of drug information associated with the pharmaceutical drugs, consumer may become frustrated with the lack of relevant information being provided by known systems. In addition, because of the number of records that may be included in a drug database, at least some known systems require significant computing time and resources to generate and display visual information on pharmacy customer mobile devices. Moreover, as the amount of information being displayed on customer devices increases, the amount of computing resources that are required to perform the search and display functions increase, thus reducing the overall performance of known computer systems.

The present invention is aimed at one or more of the problems identified above.

### SUMMARY OF THE INVENTION

In different embodiments of the present invention, systems, methods, and computer-readable storage media for generating and displaying information to users via mobile computing devices.

In one embodiment of the present invention, networked computer system for generating pharmaceutical data for use by an interactive voice response (IVR) program application stored on the mobile computing device is provided. The networked computer system includes a server computer including a processor coupled to a memory device, and a database. The database includes a list of drug information data records. Each drug information data record is associated with a corresponding pharmaceutical drug and includes a unique drug ID and corresponding drug information associated with a corresponding pharmaceutical drug. The server computer is programmed to receive an IVR request signal from a mobile computing device indicating a request to initiate an IVR operation, and including a drug ID, access the list of drug information data records and select a drug information data record associated with the received drug ID, and retrieve drug information included in the selected drug information data record. The server computer generates an IVR audio file including the corresponding drug information and transmits an IVR operation data signal to the mobile computing device including the IVR audio file to cause the mobile computing device to execute an IVR program application being stored on the mobile computing device to broadcast an audio presentation of the corresponding drug information to a user via the mobile computing device.

In another embodiment of the present invention, a computer-implemented method of operating a networked computer system for generating pharmaceutical data for use by an IVR program application stored on the mobile computing device is provided. The networked computer system includes a database and a server computer including a processor coupled to a memory device. The method includes the steps of the server computer receiving an IVR request signal from a mobile computing device indicating a request to initiate an IVR operation and including a drug ID, and accessing a database including a list of drug information data records. Each drug information data record is associated with a corresponding pharmaceutical drug and includes a unique drug ID and corresponding drug information associated with a corresponding pharmaceutical drug. The server computer selects a drug information data record associated with the received drug ID, retrieves drug information included in the selected drug information data record, and generates an IVR audio file including the corresponding drug information. The server computer transmits an IVR operation data signal to the mobile computing device including the IVR audio file, and initiates an IVR program application being stored on the mobile computing device to cause the mobile computing device to broadcast an audio presentation of the corresponding drug information to a user via the mobile computing device.

In yet another embodiment, one or more non-transitory computer-readable storage media, having computer-executable instructions embodied thereon are provided. When executed by at least one processor, the computer-executable instructions cause the processor to receive an IVR request signal from a mobile computing device indicating a request to initiate an IVR operation and including a drug ID and access a database including a list of drug information data records. Each drug information data record is associated with a corresponding pharmaceutical drug and includes a unique drug ID and corresponding drug information associated with a corresponding pharmaceutical drug. The processor selects a drug information data record associated with the received drug ID, retrieves drug information included in the selected drug information data record, and generates an IVR audio file including the corresponding drug information. The processor transmits an IVR operation data signal to the mobile computing device including the IVR audio file and initiates an IVR program application being stored on the mobile computing device to cause the mobile computing device to broadcast an audio presentation of the corresponding drug information to a user via the mobile computing device.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present invention;

FIG. 2 is a schematic illustrating example components of a server computer that may be used with the system shown in FIG. 1, according to an embodiment of the present invention;

FIGS. 3-4 are flowcharts of methods that may be used with the system shown in FIG. 1, according to embodiments of the present invention;

FIGS. 5-8 are illustrations of exemplary database records generated by the system of FIG. 1, according to embodiments of the present invention;

FIGS. 9-14 are illustrations of exemplary screenshots from the system of FIG. 1, according to an embodiment of the present invention; and

FIG. 15 is an illustration of an exemplary pharmacy drug label that may be generated by the system of FIG. 1 to be affixed to a prescription medication container, according to an embodiment of the present invention.

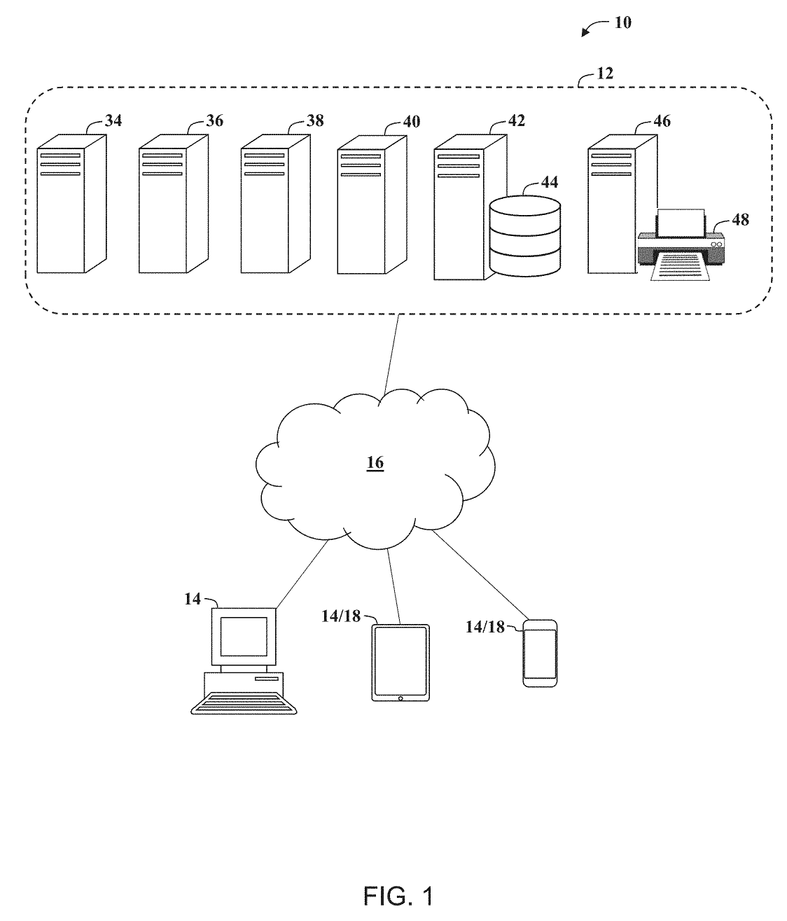

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

With reference to the FIGS. and in operation, the present invention provides a networked computer system, methods and computer product media that includes a pharmacy server system that includes an interactive voice response (IVR) computer server system that allows a human pharmacy customer to interact and operate the system using voice commands and provides audio presentations of information associated with the pharmacy customer. In the illustrated embodiment, the system 10 installs an IVR computer application program on a mobile device associated with the pharmacy customer to allow the customer to interact with the IVR computer server system using voice commands and inputs received via the mobile device. In addition, the IVR computer server system may retrieve a user pharmacy account records associated with the pharmacy customer and provide audio presentations of information included in the corresponding account record.

In addition, the IVR computer application program allows the customer to capture video images of pharmacy drug labels affixed to prescription drug medication bottles and request audio presentations of drug information associated with the corresponding prescription drugs. For example, in one embodiment, the pharmacy drug label may include a digital watermark that indicates information associated with the corresponding prescription drug. The IVR computer application operates the mobile device to enable the pharmacy customer to capture an image of the pharmacy drug label and transmit the captured image to the IVR computer server system. The IVR computer server system recognizes the digital watermark included in the captured image, identifies the prescription drug associated with the digital watermark, and generates and transmits audio files to the mobile device including information associated with the identified prescription drug. Upon receipt of the audio files, the IVR computer application causes the mobile device to broadcast an audio presentation of the audio file including information associated with the prescription drug. In one embodiment, the IVR computer application transmit verbal requests received from the customer via the mobile device to the IVR computer server system to allow the pharmacy customer to interact with the IVR computer server system and obtain additional information. The IVR computer server system is configured to receive signals from the mobile device indicating the verbal requests and generate and transmit information to the mobile device in response to the received request.

For example, in one embodiment, the pharmacy customer may initiate the IVR application on a mobile device, scan an image of a pharmacy medication label, and receive an audio presentation of information associated with pharmaceutical drug associated with the pharmacy medication label. In addition, the IVR computer server system authenticates an identity of the pharmacy customer by requesting login information to be provided by the customer via the mobile device. The IVR computer server system may verify the received login information with customer identifying information included in corresponding user pharmacy account records. The system may also allow the pharmacy customer to identify additional users such as, for example, family, friends, and healthcare professionals, that may be able to access pharmacy records associated with the pharmacy customer via the IVR computer server system, to provide the additional users with the information associated with the pharmacy customer.

By generating IVR audio files and presenting audio presentation of pharmaceutical drug information to users via mobile devices, the system improves the speed and functionality of known computing systems by reducing the amount of computing time required to generate visual data records including similar information being transmitted to the mobile devices, thus reducing the computing resources required to generate and maintain pharmacy customer records.

For clarity in discussing the various functions of the system 10, multiple computers and/or servers are discussed as performing different functions. These different computers (or servers) may, however, be implemented in multiple different ways such as modules within a single computer, as nodes of a computer system, etc. . . . The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

Other features of the system 10 can be found in the following commonly owned US Patent Applications, which are hereby incorporated by reference: U.S. patent application Ser. No. N/A, filed on Jan. 28, 2016 (Attorney Docket Number 068571.00242); U.S. patent application Ser. No. N/A, filed on Jan. 28, 2016 (Attorney Docket Number 068571.00243); U.S. patent application Ser. No. N/A, filed on Jan. 28, 2016 (Attorney Docket Number 068571.00244); U.S. patent application Ser. No. N/A, filed on Jan. 28, 2016 (Attorney Docket Number 068571.00245); U.S. patent application Ser. No. N/A, filed on Jan. 28, 2016 (Attorney Docket Number 068571.00247); U.S. patent application Ser. No. N/A, filed on Jan. 28, 2016 (Attorney Docket Number 068571.00248); U.S. patent application Ser. No. N/A, filed on Jan. 28, 2016 (Attorney Docket Number 068571.00249); U.S. patent application Ser. No. N/A, filed on Jan. 28, 2016 (Attorney Docket Number 068571.00250); U.S. patent application Ser. No. N/A, filed on Jan. 28, 2016 (Attorney Docket Number 068571.00251); U.S. patent application Ser. No. N/A, filed on Jan. 28, 2016 (Attorney Docket Number 068571.00252); and, U.S. patent application Ser. No. N/A, filed on Jan. 28, 2016 (Attorney Docket Number 068571.00253).

In the illustrated embodiment, the system 10 includes a server system 12 that is coupled in communication with one or more user computing devices 14 via a communications network 16. The communications network 16 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The user computing device 14 may include any suitable device that enables a user to access and communicate with the system 10 including sending and/or receiving information to and from the system 10 and displaying information received from the system 10 to a user. For example, in one embodiment, the user computing device 14 may include, but is not limited to, a desktop computer, a laptop or notebook computer, a tablet computer, smartphone/tablet computer hybrid, a personal data assistant, a handheld mobile device including a cellular telephone, and the like. The user computing device 14, as well as any other connected computer systems and their components included in the system 10, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

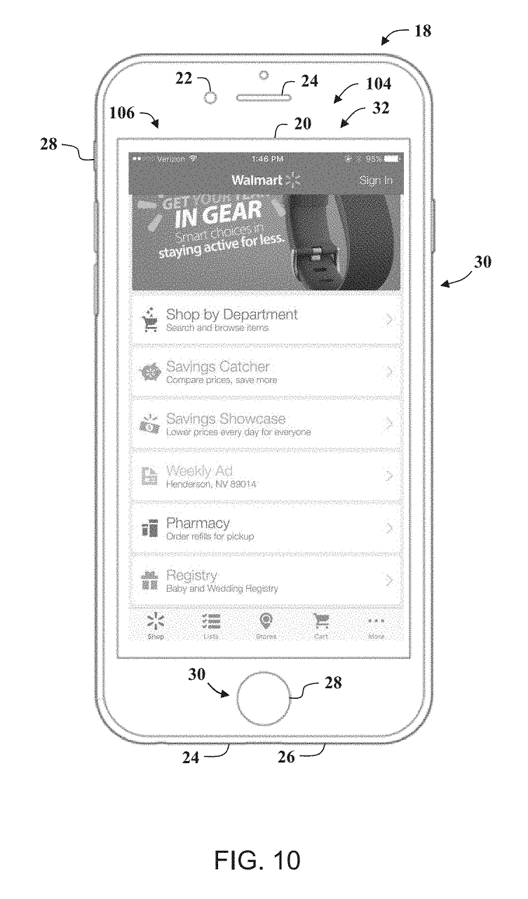

In one embodiment, the user computing device includes a mobile computing device 18 (shown in FIG. 10) such as, for example, a smartphone such as an iPhone™. The mobile computing device 18 includes a processor coupled to a memory device, and a database for storing various programs and data for use in operating the mobile computing device 18. The mobile computing device 18 may also include a touchscreen display device 20, one or more video image cameras 22, one or more speakers 24, a microphone 26, at least one input button 28, and one or more sensors 30 including, but not limited to, a touch ID fingerprint sensor 30 coupled to an input button 28, a barometer, a three-axis gyro, an accelerometer, proximity sensor, and an ambient light sensor. In addition, the mobile computing device 18 may also include a Wi-Fi antenna, a cellular network antenna, a Bluethooth^{TM} communications device, assisted GPS and GLONASS, a digital compass, and an iBeacon microlocation device.

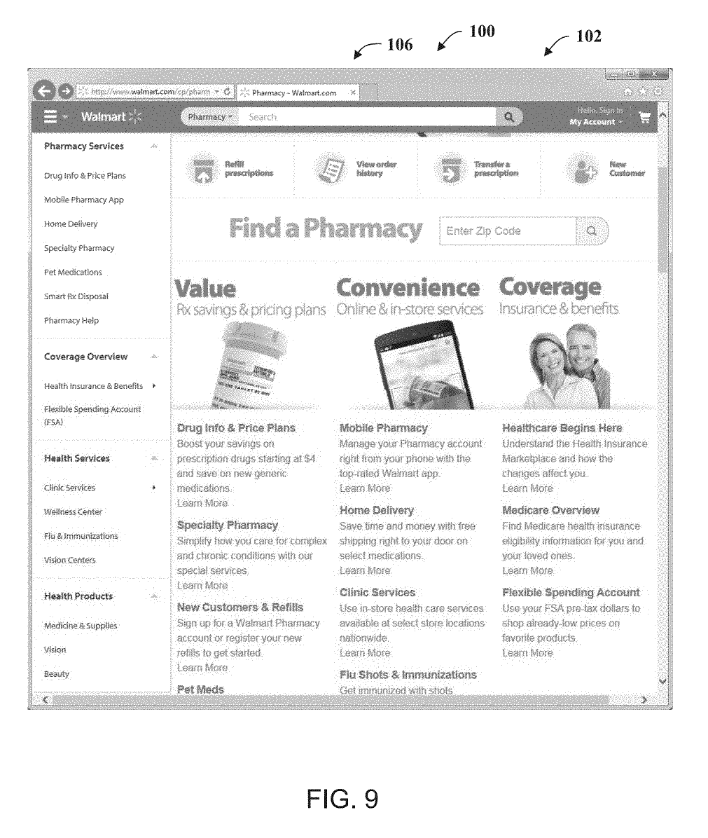

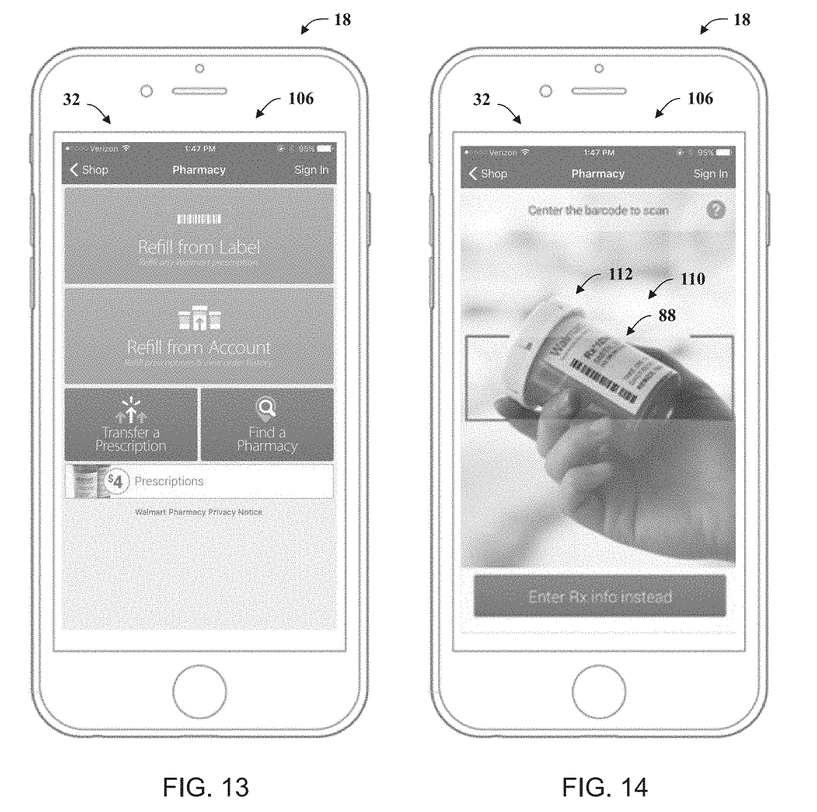

In the illustrated embodiment, the mobile computing device 18 includes a web browser program stored in the memory device. The processor executes the web browser program to display web pages on the touchscreen display device 20 that includes information received from the server system 12 to enable a user to interact with and operate the server system 12. In addition, the mobile computing device 18 may be programmed to store and execute a computer program application that displays user interfaces 32 (shown in FIGS. 9-14) on the touchscreen display device 20 that allows the user to access the server system 12 to retrieve and store information within the server system 12 as well as interact with and operate the server system 12. In addition, in one embodiment, the system 10 may install one or more mobile computer application programs in the memory device of the mobile computing device 18. When initiated by the processor of the mobile computing device 18, the mobile computer application program causes the processor of the mobile computing device 18 to perform some or all of the functions of the server system 12. For example, in one embodiment, the server system 12 may install an IVR mobile computer application program on the mobile computing device 18 to allow the user to operate the mobile computing device 18 to transmit data to and receive data from the server system 12. In addition, the IVR mobile computer application program may operate the mobile device speakers 24 to broadcast audio presentations to the user. In addition, the IVR mobile computer application program may receive verbal requests from the user via the mobile device microphone 26 and generate and transmit signals indicating the verbal requests to the server system 12 to allow the user to interact with and operate the server system 12. Moreover, the IVR mobile computer application program may operate the mobile device camera 22 to capture video images using the camera 22 and generate and transmit signals indicating the captured images to the server system 12.

In the illustrated embodiment, the server system 12 includes a website hosting server 34, e-receipts server 36, a pharmacy account server 38, an interactive voice response 40, a database server 42, a database 44, a printer server 46 and one or more printers 48 coupled to the printer server 46. The database server 42 includes a memory device that is connected to the database 44 to retrieve and store information contained in the database 44. The database 44 contains information on a variety of matters, such as, for example, web pages associated with one or more websites, search queries, pharmaceutical drug information, refill information, customer authentication information, customer pharmacy account information, product records, notification messages, mobile device identifies, mobile device application program interfaces (APIs), and/or any suitable information that enables the system 10 to function as described herein. In one embodiment, some or all of the information contained in the database 44 may also be stored in the database of the mobile computing device 18.

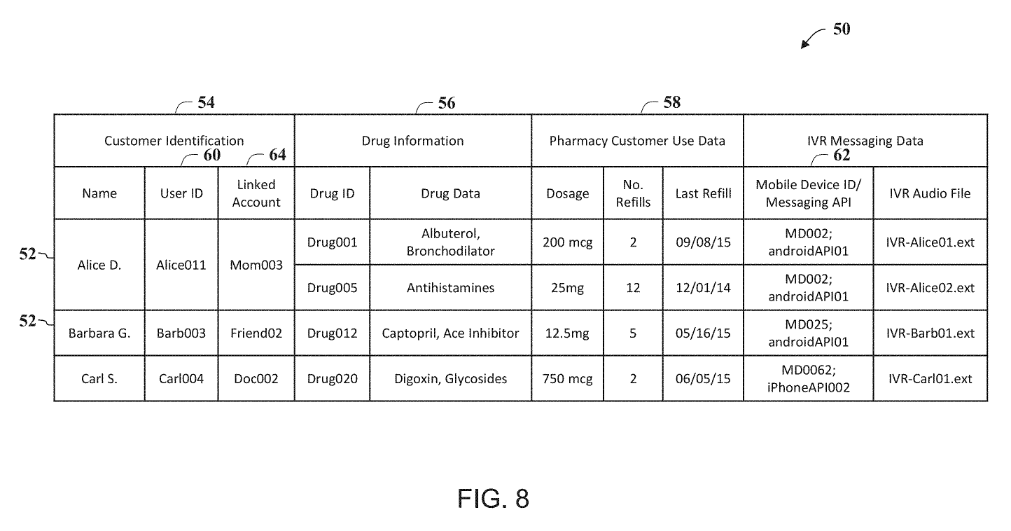

In the illustrated embodiment, the database 44 includes a pharmacy account list 50 (shown in FIG. 8) that includes a plurality of user pharmacy account records 52. Each user pharmacy account record 52 is associated with a corresponding pharmacy customer and includes customer identification data 54, pharmaceutical drug data 56 including information associated with pharmaceutical drugs prescribed to and/or purchased by the corresponding pharmacy customer, and pharmacy customer use data 58 including information associated with the pharmacy customer's use of the corresponding pharmaceutical drug. The customer identification data 54 includes user identifying data such as, for example, a unique customer ID 60 and/or password. The customer identification data 54 may also include user contact information such as, for example, a phone number, an email, and/or a mobile device data 62 associated with a mobile computing device 18 associated with the corresponding pharmacy customer. For example, the mobile device data 62 may include, but is not limited to, a unique mobile device ID, operating system, phone number, IP address, mobile device API, and/or any suitable information that enables the system 10 to communicate with the corresponding mobile computing device 18.

In one embodiment, the customer identification data 54 may also include a linked account information 64 associated with additional users that are associated with the corresponding pharmacy customer. The linked account information 64 may include a unique linked user ID and/or password that is associated with the additional users to allow the additional users to access some or all of the information being included in the user pharmacy account record 52. For example, the linked account information 64 may be associated with friends, relatives, and/or healthcare professionals associated with the pharmacy customer. The linked account information may also include contact information such as, for example, emails and/or text and phone numbers associated with the additional users, and/or include information associated with another user pharmacy account record.

In one embodiment, the pharmaceutical drug data 56 may include, but is not limited to, a unique drug ID associated with the pharmaceutical drug, a drug name, a pharmaceutical drug description, a drug category, and/or any suitable information associated with the corresponding pharmaceutical drug. The pharmacy customer use data 58 may include information indicating activities associated with the pharmacy customers such as, for example, dosage information, a number of refills remaining, a refill frequency, a date and/or time of the last refill purchase, purchase date, and/or prescription expiration, and/or any suitable information associated with pharmacy customer activity.

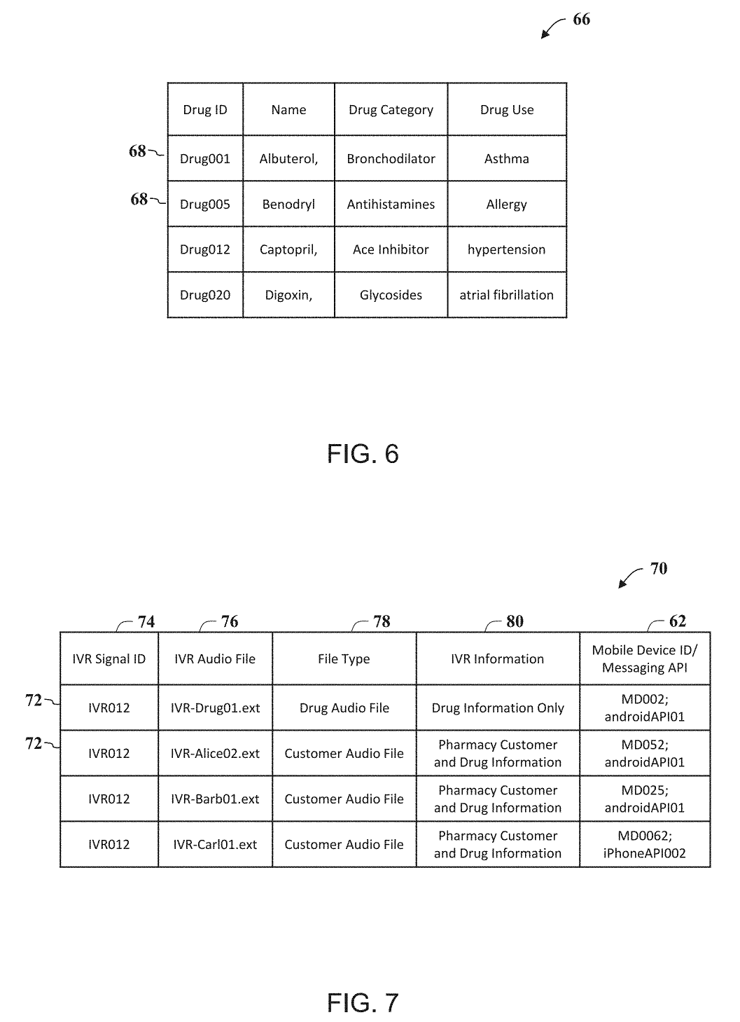

The database 44 may also include a drug data record list 66 (shown in FIG. 6) that includes a plurality of drug information data records 68. Each drug information data record 68 is associated with a corresponding pharmaceutical drug and includes information such as, for example, a including information unique drug ID associated with the pharmaceutical drug, a drug name, a pharmaceutical drug description, a drug category, and/or any suitable information associated with the corresponding pharmaceutical drug. For example, in one embodiment, each drug information data records 68 may include information similar to the pharmaceutical drug data 56 included in the user pharmacy account records 52.

In one embodiment, the database 44 may also include an IVR operation signal list 70 (shown in FIG. 7) that includes a plurality of IVR operation data signal records 72. Each IVR operation data signal record 72 includes information associated with IVR signals being generated by the server system 12 and being transmitting to the user computing device 14. In one embodiment, the IVR operation data signal record 72 includes information that may be used by the IVR mobile computer application program installed on a mobile computing device 18 to enable the server system 12 to interact with the IVR mobile computer application program and the mobile computing device 18. In the illustrated embodiment, each IVR operation data signal record 72 includes a unique IVR signal ID 74, an IVR audio file 76, and a record description information including a file type 78 and IVR information data 80. The IVR audio file 76 may include information associated with an audio presentation and contain a file format (e.g. .wav, .mp3, .mp4) that is accessible by the corresponding mobile computing device 18. The file type 78 and IVR information data 80 contain data describing the information included in the corresponding IVR audio file 76 such as, for example, drug information and/or pharmacy customer information. In one embodiment, the IVR operation data signal record 72 may include mobile device data 62 that includes information associated with the receiving mobile computing device 18 including information such as, for example, a mobile device ID and/or a mobile device API file.

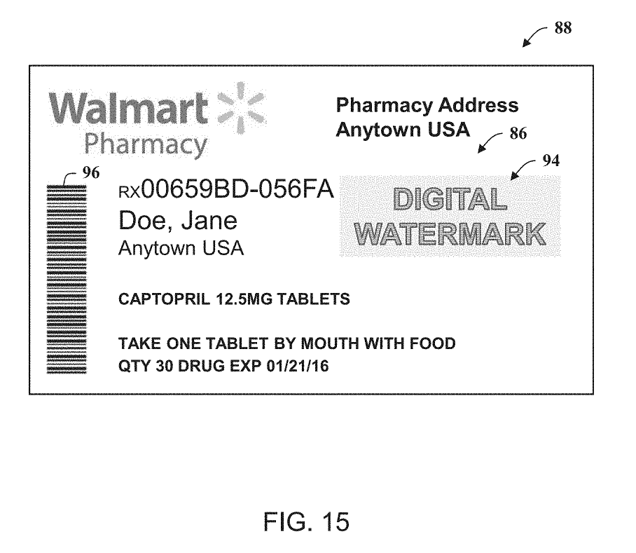

The database 44 may also include an IVR request code list 82 (shown in FIG. 5) that includes a plurality of IVR request code records 84 for use in generating a digital IVR request code 86 that may be displayed on pharmacy drug labels 88 (shown in FIG. 15). In the illustrated embodiment, each IVR request code record 84 may include a unique IVR request code ID 90, a customer ID 60 associated with the a pharmacy customer, a drug ID associated with a pharmaceutical drug. In addition, each IVR request code record 84 may include an IVR code file 92 that includes information for use in generating the digital IVR request code 86. For example, in one embodiment, the digital IVR request code 86 may be included in a digital watermark 94 that may be printed on a corresponding pharmacy drug label 88. The IVR code file 92 may include a digital watermark file for use in generating digital watermarks that are associated with the corresponding IVR request code records 84 and is recognizable by the server system 12. In other embodiments, the digital IVR request code 86 may be included in a barcode 96 (shown in FIG. 15), and/or a QR code.

The website hosting server 34 is configured to host a website 100 that is accessible by a user via one or more user computing devices 14. The website hosting server 34 retrieves and stores webpages 102 (shown in FIG. 9) associated with one or more websites 100 in response to requests received by the user via the user computing device 14 to allow users to interact with the website and search and/or purchase products such as, for example, goods and/or services via the website. In one embodiment, the website hosting server 34 is configured to generate and display webpages 102 associated with the website in response to requests being received from consumers via corresponding web browsers that are displayed on the user computing devices 14. In addition, the website hosting server 34 may be configured to generate and display a mobile webpage 104 (shown in FIGS. 10-14) that is displayed on one or more mobile computing devices 18. For example, in one embodiment, the website hosting server 34 may display a pharmacy webpage 106 (shown in FIGS. 9-14) in response to receiving a user request that allows a user to access a corresponding user pharmacy account record 52, input product search requests including search criteria including one or more search terms, purchase pharmaceutical drugs, request prescription refills, request pharmacist consultations, schedule pharmacy and/or medical clinic appointments, and the like.

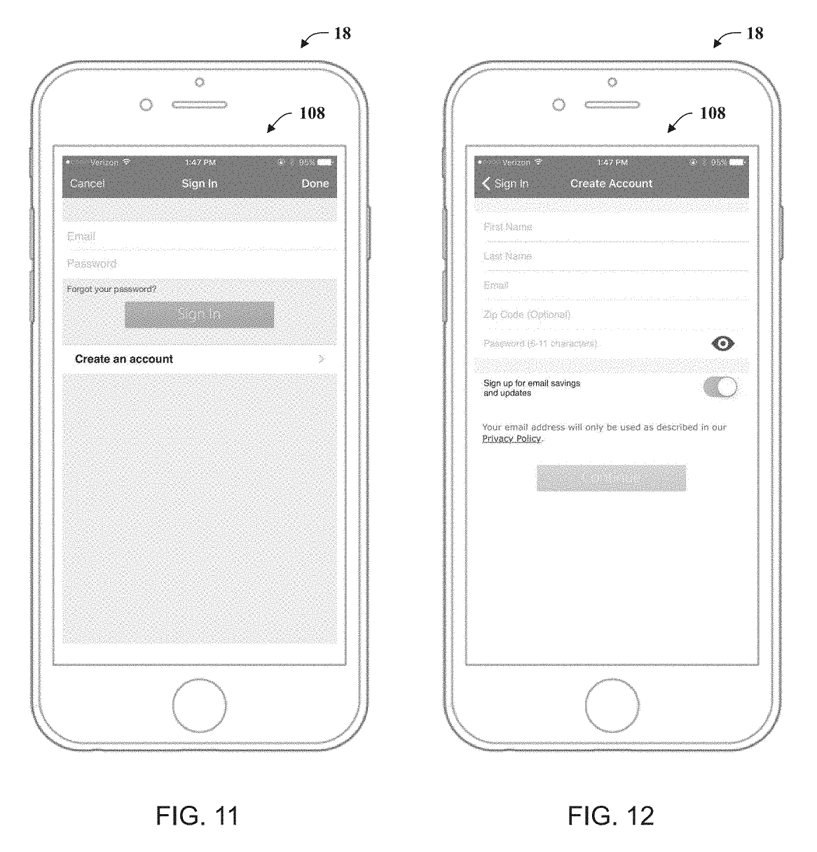

The website hosting server 34 may allow customers to login and access corresponding customer pharmacy accounts including account information such as, for example, previous purchases, pending prescription orders, pending medication refills, and/or pharmaceutical drug information. For example, the website hosting server 34 may display a login page 108 (shown in FIGS. 11-12), receive a unique customer ID such as, for example, a username and/or password, and identify the customer account associated with the unique customer ID to enable the identified customer to access information and/or features associated with the corresponding customer pharmacy account.

The e-receipts server 36 receives and stores information associated with consumer retail purchases in the database 44 and is programmed to generate and store electronic receipt data associated with the consumer retail purchases. In addition, the e-receipts server 36 may be programmed to transmit signals indicating pharmacy customer purchases to the pharmacy account server 38. In one embodiment, the e-receipts server 36 may communicate with a plurality of point-of-sale (POS) systems as well as other computer systems at each of the one or more physical store locations (e.g., on an internal corporate network) to facilitate business operations for the corresponding entity. For example, a pharmacy customer may purchase a pharmaceutical drug using a POS system at a store location. The e-receipts server 36 may generate e-receipt data indicating the purchase and transmit the e-receipt data to the pharmacy account server 38 for use in modifying a corresponding user pharmacy account record 52 to include information associated with the pharmaceutical drug purchase.

The e-receipts server 36 is programed to receive application identifiers and digital receipt data, including item data for one or more purchased items, from POS systems at various different store locations, and generate and store digital receipts from received receipt data. Generating digital receipts can include item data for items included in corresponding digital receipt data (but potentially in a different format, for example, a format deliverable to mobile devices). Formulated digital receipts can also contain other data related to a transaction, such as, for example, the payment method used for the transaction, coupons, surveys, etc. Additional details of adjacent special symbol positions, which may be used in the present invention, are described in U.S. patent application Ser. No. 13/730,721 to Argue et al, filed Dec. 28, 2012, titled “Searching Digital Receipts at a Mobile Device”, the disclosure of which is incorporated herein by reference in its entirety.

The pharmacy account server 38 is programmed to monitor activities of pharmacy customers including the purchase and use of prescription pharmaceutical medications to generate and store pharmacy records associated with the pharmacy customer activities. For example, in one embodiment, the pharmacy account server 38 may communicate with the IVR mobile computer application program installed on a mobile computing device 18 to transmit and receive data and information from the mobile computing device 18 to facilitate presenting audio broadcasts of pharmaceutical drug information and/or pharmacy customer information to a pharmacy customer or associated user via the mobile computing device 18.

In the illustrated embodiment, the pharmacy account server 38 is programmed to receive an interactive voice response (IVR) request signal from a mobile computing device 18 indicating a request to initiate an IVR operation to present an audio presentation of information associated with pharmaceutical drugs. In one embodiment, the pharmacy account server 38 receives the IVR request signal including a drug ID associated with a pharmaceutical drug. The pharmacy account server 38 accesses the drug data record list 66 stored in the database 44 and selects a drug information data record 68 associated with the received drug ID. The pharmacy account server 38 retrieves the drug information included in the selected drug information data record 68 and transmits the retrieved drug information to the IVR server 40 for use in generating an IVR audio file 76. The IVR server 40 generates an IVR operation data signal including the IVR audio file including the corresponding drug information and transmits the IVR operation data signal to the pharmacy account server 38. The pharmacy account server 38 generates and transmits an IVR operation data signal to the mobile computing device 18 including the IVR audio file to cause the mobile computing device 18 to execute the IVR mobile computer program application stored on the mobile computing device 18 to broadcast an audio presentation of the corresponding drug information included in the IVR audio file to a user.

In one embodiment, the IVR request signal may include a customer ID associated with a pharmacy customer. Upon receiving the IVR request signal, the pharmacy account server 38 may access the pharmacy account list 50 and select a user pharmacy account record 52 as a function of the received customer ID. For example, the pharmacy account server 38 may select a user pharmacy account record 52 having customer identification data 54 that includes the received customer ID and/or is associated with the received customer ID. The pharmacy account server 38 may retrieve the pharmaceutical drug data 56 and the pharmacy customer use data 58 included in the selected user pharmacy account record 52 and transmit the pharmaceutical drug data 56 and the pharmacy customer use data 58 to the IVR server 40 for use in generating one or more IVR audio files as a function of the pharmaceutical drug data 56 and the pharmacy customer use data 58 to include information associated with pharmaceutical drugs prescribed to and/or purchased by the corresponding pharmacy customer, and include pharmacy customer information associated with the pharmacy customer's use of the corresponding pharmaceutical drug. For example, the pharmacy customer information may include, but is not limited to, a number of remaining refills associated with the corresponding pharmaceutical drug, a date of a scheduled refill, and/or healthcare provider contact information such as, for example, a pharmacists, medical care professional, and/or a physician. In one embodiment, the selected user pharmacy account record 52 may include a plurality of drug IDs associated with a plurality of prescription pharmaceutical drugs associated with the corresponding pharmacy customer. The IVR server may generate a plurality of IVR audio files for use by the IVR program application being executed on the mobile computing device 18 with each IVR audio file being associated with a different prescription pharmaceutical drug.

In the illustrated embodiment, the IVR mobile computer application program operates the mobile computing device 18 to receive verbal input from the user and transmits verbal input signals indicating the user verbal input to the server system 12. The IVR server 40 may receive the verbal input signals from the mobile computing device 18 and generate one or more IVR audio files including information that is responsive to the user requests included in received user verbal inputs. The server system 12 transmits the selected IVR audio files to the mobile computing device 18 for use in broadcasting an audio presentation of the selected IVR audio files to allow the user to interact with the server system 12 to obtain additional information associated with the pharmaceuticals drug and/or the user pharmacy account record.

In one embodiment, the pharmacy account server 38 receives the IVR request signal including a unique IVR identifier, accesses the IVR request code list 82, selects a IVR request code record 84 associated with the unique IVR identifier, and retrieves the unique customer ID and/or drug ID included in the selected IVR request code record 84 for use in generated an IVR audio file.

For example, in one embodiment, the unique IVR identifier may include a digital IVR request code 86 displayed on a physical printed prescription drug label 88 (shown in FIG. 15). The IVR mobile computer application program allows the user to use the mobile computing device camera 22 to capture a video image 110 of a printed prescription drug label 88 including the digital IVR request code 86. The IVR mobile computer application program generates and transmits the IVR request signal including data associated with the captured video image 110 of the printed prescription drug label 88 and digital IVR request code 86 to the pharmacy account server 38. Upon receiving the captured video image 110, the pharmacy account server 38 identifies the digital IVR request code 86 included on the printed prescription drug label 88, accesses the IVR request code list 82, and selects an IVR request code record 84 associated with the digital IVR request code 86. The digital IVR request code 86 may include, but is not limited to, a digital watermark, a bar code, a QR code, and/or any suitable identifier that may be included in a captured video image.

In the illustrated embodiment, the pharmacy account server 38 may verify the identity of the user requesting the IVR information to ensure that customer information is provided only to users associated with the pharmacy customer account such as the corresponding pharmacy customer and/or friends, relatives, and/or healthcare professionals associated with the pharmacy customer. For example, in one embodiment, the IVR request signal may include a mobile user ID that is associated with the mobile computing device 18 and the associated user of the mobile computing device 18. For example, the server system 12 may cause the IVR mobile computer application program to display a mobile login screen 108 (shown in FIGS. 11-12) and require the user to enter a unique mobile user ID via the mobile computing device 18 to initiate an IVR operation. The mobile computing device 18 transmits the IVR request signal including the mobile user ID to the server system 12.

The pharmacy account server 38 receives the IVR request including the digital IVR request code 86 and the mobile user ID. The pharmacy account server 38 accesses the pharmacy account list 50 and selects a user pharmacy account record 52 as a function of the customer ID associated with the received digital IVR request code 86. The pharmacy account server 38 determines whether the received mobile user ID is associated with the customer identification data 54 included in the selected user pharmacy account record 52. The pharmacy account server 38 generates an IVR audio file including the pharmaceutical drug data 56 and the pharmacy customer use data 58 included in the selected user pharmacy account record 52 upon determining that the received mobile user ID is associated with the corresponding customer identification data 54. For example, the mobile user ID may be associated with the customer ID and/or the linked user ID. If the pharmacy account server 38 determines that the mobile user ID is not associated with the selected user pharmacy account record 52, the pharmacy account server 38 may limit the amount of information be presented in the IVR operation by accessing the drug data record list 66, select a drug information data record 68 associated with the drug ID associated with the received digital IVR request code 86, and generate an IVR audio file that includes the drug information included in the selected drug information data record 68.

In the illustrated embodiment, the IVR server 40 is programed to receive information from the pharmacy account server 38 and generate IVR operation data signal records 72 as a function of the received information. For example, in one embodiment, the IVR server 40 may receive drug information from a corresponding drug information data record 68 and/or pharmaceutical drug data 56 and/or the pharmacy customer use data 58 from the pharmacy account server 38 and generate an IVR operation data signal record 72 including a unique IVR signal ID 74, one or more IVR audio files that include information associated with the received drug information, pharmaceutical drug data 56, and/or the pharmacy customer use data 58, and a record description information including a file type 78 and IVR information data 80. The IVR server 40 transmits the IVR operation data signal record 72 to the pharmacy account server 38 for use in transmitting the IVR audio files to the mobile computing device 18.

In the illustrated embodiment, the IVR server 40 is also programmed to generate a digital IVR request code 86 that may be displayed on pharmacy drug labels 88 (shown in FIG. 15). In one embodiment, the IVR server 40 may receive a digital code request from the pharmacy account server 38 including a customer ID and drug ID associated with user pharmacy account record 52. Upon receiving the digital code request, the IVR server generates an IVR request code record 84 including a unique IVR request code ID 90, the received customer ID, the received drug ID, and an IVR code file 92 including information for use in generating the digital IVR request code 86. The IVR server 40 then transmits the IVR code file 92 to the printer server 46 for use in generating and printing a pharmacy drug label 88.

In the illustrated embodiment, the printer server 46 receives a request to print a pharmacy drug label from the pharmacy account server 38 and generates and prints a pharmacy drug label 88 that may be affixed to a pharmaceutical drug medication bottle 112 (shown in FIG. 14). For example, the pharmacy account server 38 may receive a request to generate a user pharmacy account record 52 associated with a purchase of a pharmaceutical drug from a user computing device 14 located at a retail pharmacy and/or a POS station located with a consumer retail store. The pharmacy account server 38 transmits drug information associated with the purchased pharmaceutical drug to the printer server 46. In addition, the IVR server 40 transmits an IVR code file 92 associated with the purchased pharmaceutical drug to the printer server 46. The printer server 46 then generates the digital IVR request code 86 as a function of the IVR code files 92 and prints the pharmacy drug label 88 including the received drug information and the digital IVR request code 86 including digital watermark, a bar code, a QR code, and/or any suitable identifier that may be recognized by the pharmacy account server 38. The printed pharmacy drug label 88 may then be affixed to the pharmaceutical drug medication bottle and provided to the pharmacy customer.

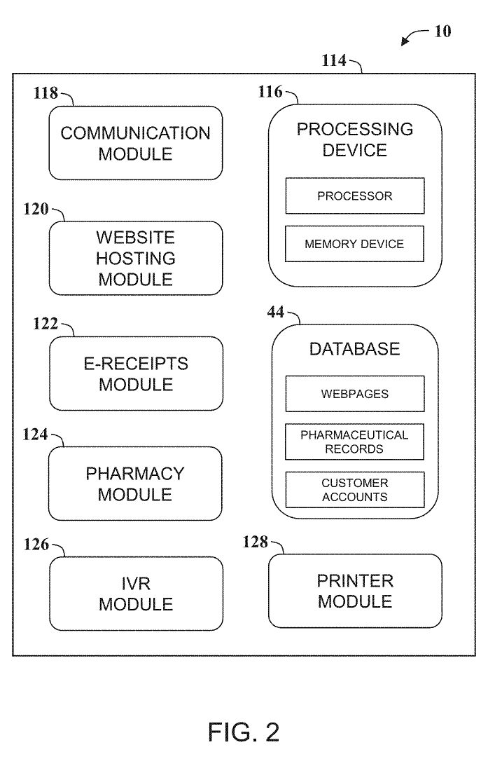

Referring to FIG. 2, in one embodiment, the system 10 may include a system server computer 114 that is configured to perform the functions of the website hosting server 34, the e-receipts server 36, the pharmacy account server 38, the IVR server 40, the database server 42, and the printer server 46. In the illustrated embodiment, the system server 114 includes a processing device 116 and the database 44.

The processing device 116 executes various programs, and thereby controls components of the system server 114 according to user instructions received from the user computing device 14. The processing device 116 may include memory, e.g., read only memory (ROM) and random access memory (RAM), storing processor-executable instructions and one or more processors that execute the processor-executable instructions. In embodiments where the processing device 116 includes two or more processors, the processors can operate in a parallel or distributed manner. In an example, the processing device 116 may execute a communications module 118, a website hosting module 120, an e-receipts module 122, a pharmacy account module 124, an IVR module 126, and a printer module 128.

The processing device 116 may also include a memory device for storing programs and information in the database 44, and retrieving information from the database 44 that is used by the processor to perform various functions described herein. The memory device may include, but is not limited to, a hard disc drive, an optical disc drive, and/or a flash memory drive. Further, the memory device may be distributed and located at multiple locations.

The communications module 118 retrieves various data and information from the database 44 and sends information to the user computing device 14 via the communications network 16 to enable the user to access and interact with the system 10. In one embodiment, the communications module 118 displays various images on a graphical interface of the user computing device 14 preferably by using computer graphics and image data stored in the database 44 including, but not limited to, web pages, pharmacy records, pharmacy notification messages, product lists, and/or any suitable information and/or images that enable the system 10 to function as described herein.

The website hosting module 120 may be programmed to perform some or all of the functions of the website hosting server 34 including hosting various web pages associated with one or more websites that are stored in the database 44 and that are accessible to the user via the user computing device 14. The website hosting module 120 may be programmed to generate and display web pages associated with a website in response to requests being received from users via corresponding web browsers.

The e-receipts module 122 may be programmed to perform some or all of the functions of the e-receipts server 36 including generating, receiving, and storing e-receipt data in the database 44 and detecting purchases being made by the pharmacy customers.

The pharmacy account module 124 may be programmed to perform some or all of the functions of the pharmacy account server 38 including monitoring activities associated with pharmacy customers including consumer purchase and/or prescription refill requests. The pharmacy account module 124 may also be programmed to receive an IVR request signal from a mobile computing device 18 and initiate an IVR operation to present an audio presentation of information associated with pharmaceutical drugs.

The IVR module 126 may be programmed to perform some or all of the functions of the IVR server 40 including receiving pharmacy data information from the pharmacy account module 124 and generate IVR operation data signal records 72 as a function of the received information.

The printer module 128 may be programmed to perform some or all of the functions of the printer server 46 including receiving a request to print a pharmacy drug label from the pharmacy account module 124 and generating a pharmacy drug label 88 that may be printed by the printer 48 and affixed to a pharmaceutical drug medication bottle 112 (shown in FIG. 14).

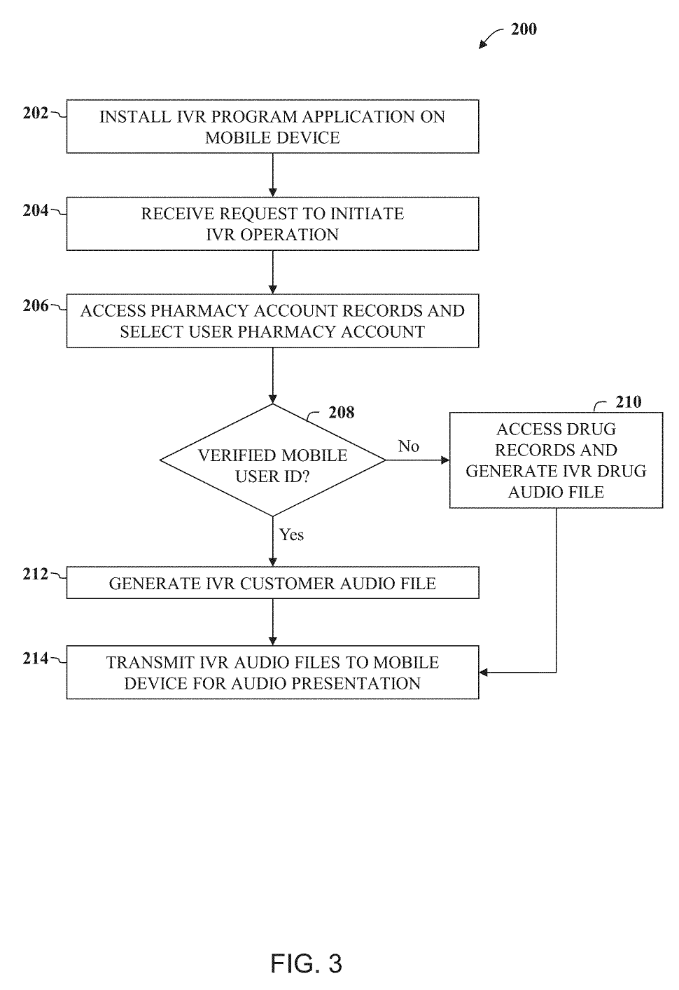

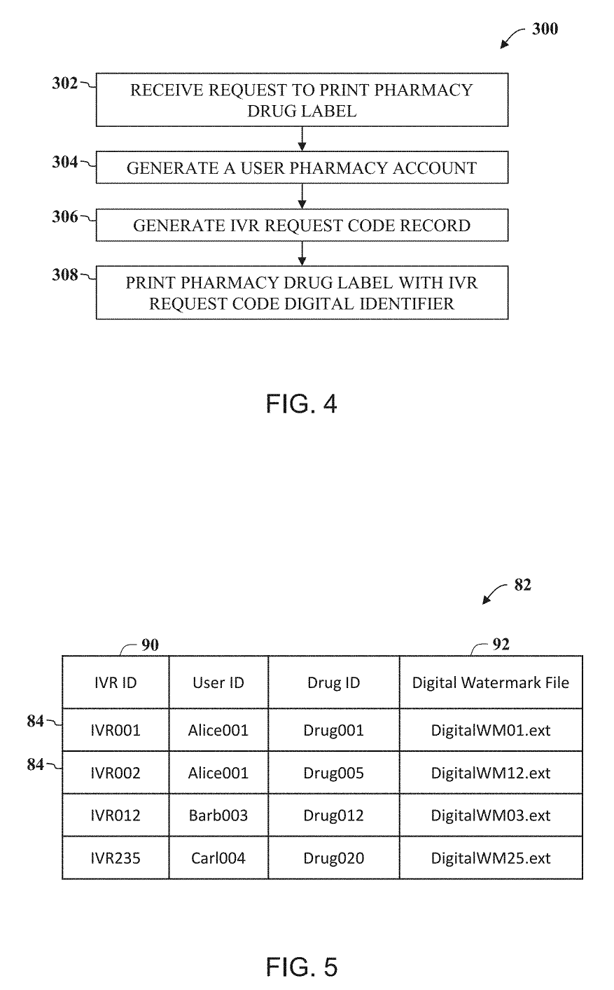

FIGS. 3-4 are flowcharts of methods 200 and 300 that may be used with the system 10 for monitoring activities of pharmacy customers and generating pharmaceutical data. The methods include a plurality of steps. Each method step may be performed independently of, or in combination with, other method steps. Portions of the methods may be performed by any one of, or any combination of, the components of the system 10. FIGS. 9-14 are exemplary graphical displays that may be displayed by the system 10.

In the illustrated embodiment, in method step 202, the server system 12 installs an IVR mobile computer application program on a mobile computing device 18 to enable a user to interact with an operate the system server 114 to provide audio presentations of information associated with pharmaceutical drugs via the mobile computing device 18.

In method step 204, the pharmacy account server 38 receives an IVR request signal from a mobile computing device 18 indicating a request to initiate an IVR operation. For example, in one embodiment, the user may initiate the IVR mobile computer application program to accesses a mobile login webpage 108 to enter a unique username and password, and to operate the mobile device camera 22 to capture an video image 110 of a pharmacy drug label 88. The mobile computing device 18 transmits the IVR request signal including the captured video image 110 and a mobile user ID indicating the user entered username and password to the pharmacy account server 38.

In method step 206, the pharmacy account server 38 receives the IVR request signal including the captured video image 110 and detects the a digital IVR request code 86 displayed on a physical printed prescription drug label 88. The pharmacy account server 38 accesses the IVR request code list 82, selects a IVR request code record 84 associated with the digital IVR request code 86, and retrieves the unique customer ID and/or drug ID included in the selected IVR request code record 84. The pharmacy account server 38 also accesses the pharmacy account list 50 and selects a user pharmacy account record 52 as a function of the retrieved customer ID.

In method step 208, the pharmacy account server 38 verifies the received mobile user ID and determines if the received mobile user ID is associated with the customer identification data 54 included in the selected user pharmacy account record 52. For example, the pharmacy account server 38 may determine if the received mobile user ID matches the customer ID and/or the linked user ID contained in the selected user pharmacy account record 52.

If the pharmacy account server 38 determines that the received mobile ID is not associated with the customer identification data 54, the pharmacy account server 38 initiates method step 210. In method step 210, the pharmacy account server 38 accesses the drug data record list 66 stored in the database 44 and selects a drug information data record 68 associated with the received drug ID. The pharmacy account server 38 retrieves the drug information included in the selected drug information data record 68 and transmits the retrieved drug information to the IVR server 40 for use in generating an IVR audio file 76. The IVR server 40 generates an IVR operation data signal including the IVR audio file 76 including the corresponding drug information and transmits the IVR operation data signal to the pharmacy account server 38.

If the pharmacy account server 38 determines that the received mobile ID is associated with the pharmacy customer identification data 54, the pharmacy account server 38 initiated method step 212 and retrieves the pharmaceutical drug data 56 and the pharmacy customer use data 58 included in the selected user pharmacy account record 52 and transmits the pharmaceutical drug data 56 and the pharmacy customer use data 58 to the IVR server 40. The IVR server 40 generates one or more IVR audio files as a function of the pharmaceutical drug data 56 and the pharmacy customer use data 58, generates an IVR operation data signal including the IVR audio files and transmits the IVR operation data signal to the pharmacy account server 38.

In method step 214, the pharmacy account server 38 generates and transmits an IVR operation data signal to the mobile computing device 18 including the IVR audio files and cause the mobile computing device 18 to execute the IVR mobile computer program application to broadcast an audio presentation of the corresponding information included in the IVR audio file to a user.

Referring to FIG. 4, the server system 12 may initiate method 300 for generating printed pharmacy drug labels. In the illustrated embodiment, in method step 302, the pharmacy account server 38 receives a request to print a pharmacy drug label 88 associated with a purchase of a pharmaceutical drug from a pharmacy customer.

In method step 304, the pharmacy account server 38 generates a user pharmacy account record 52 associated with the pharmacy drug purchase including a customer ID, a drug ID, pharmaceutical drug data 56 including information associated with the purchased pharmaceutical drug, and pharmacy customer use data 58 including information associated with the pharmacy customer's use of the corresponding pharmaceutical drug.

In method step 306, the pharmacy account server 38 transmits a request to generate a digital IVR request code 86 associated with the purchased pharmaceutical drug to the IVR server 40 including the generated customer ID and drug ID. The IVR server 40 receives the digital code request from the pharmacy account server 38 including a customer ID and drug ID, generates an IVR request code record 84 including a unique IVR request code ID 90, the received customer ID, the received drug ID, and an IVR code file 92 including information for use in generating the digital IVR request code 86.

In method step 308, the pharmacy account server 38 transmits drug information associated with the purchased pharmaceutical drug to the printer server 46. In addition, the IVR server 40 transmits an IVR code file 92 associated with the purchased pharmaceutical drug to the printer server 46. The printer server 46 then generates the digital IVR request code 86 as a function of the IVR code files and prints the pharmacy drug label 88 including the received drug information and the digital IVR request code 86. The printed pharmacy drug label 88 may then be affixed to the pharmaceutical drug medication bottle 112 and provided to the pharmacy customer.

In general, the system 10 is configured to monitor activities of pharmacy customers and generate pharmacy user account records including information associated with pharmaceutical medications being used by pharmacy customers. In addition, the system 10 is configured to operate an interactive voice response system to allow pharmacy customers to interact and operate the system using voice commands and to receive audio presentations of information included in pharmacy account records. In the illustrated embodiment, the system allows the pharmacy customer to capture video images of pharmacy drug labels affixed to prescription drug medication bottles, identifies prescription drugs associated with pharmacy drug label image, and broadcast audio presentations of information associated with the identified prescription drugs. By generating and presenting audio presentation of pharmaceutical drug information to users via mobile devices, the system improves the speed and functionality of known computing systems by reducing the amount of computing time required to generate visual data records including similar information being transmitted to the mobile devices, thus reducing the computing resources required to generate and maintain pharmacy customer records.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A system, comprising:
a database including a list of drug information data records, each drug information data record associated with a corresponding pharmaceutical drug and including a unique drug ID and corresponding drug information associated with a corresponding pharmaceutical drug; and
a server computer including a processor coupled to a memory device, the processor programmed to:
receive an interactive voice response (IVR) request signal from a mobile computing device indicating a request to initiate an IVR operation, the IVR request signal including a drug ID;
access the list of drug information data records and select a drug information data record associated with the received drug ID;
retrieve drug information included in the selected drug information data record and generate an IVR audio file including the corresponding drug information; and
transmit an IVR operation data signal to the mobile computing device including the IVR audio file to cause the mobile computing device to execute an IVR program application being stored on the mobile computing device to broadcast an audio presentation of the corresponding drug information to a user via the mobile computing device.

2. A system in accordance with claim 1, wherein the IVR audio file includes pharmacy customer information associated with a pharmacy customer.

3. A system in accordance with claim 1, wherein the IVR request signal includes a customer ID; the server computer is programmed to:
access a list of user pharmacy account records being stored in the database, each user pharmacy account record associated with a pharmacy customer and including corresponding pharmacy customer information and a corresponding unique customer ID;
select a user pharmacy account record as a function of the received customer ID; and
generate the IVR audio file including pharmacy customer information included in the selected user pharmacy account record.

4. A system in accordance with claim 3, wherein the selected user pharmacy account record includes a plurality of drug IDs associated with a plurality of prescription pharmaceutical drugs associated with the corresponding pharmacy customer, the server computer programmed to generate a plurality of IVR audio files for use by the IVR program application being executed on the mobile computing device, each IVR audio file being associated with a corresponding prescription pharmaceutical drug.

5. A system in accordance with claim 4, wherein the IVR program application is configured to operate the mobile computing device to receive verbal input from the user to cause the mobile computing device to broadcast audio presentations of each of the plurality of IVR audio files.

6. A system in accordance with claim 3, wherein the IVR request signal includes a mobile user ID associated with the mobile computing device, the server computer is programmed to:
determine if the mobile user ID is associated with the selected user pharmacy account records; and
generate the IVR audio file including pharmacy customer information included in the selected user pharmacy account record upon determining that the received mobile user ID is associated with the selected user pharmacy account record.

7. A system in accordance with claim 3, wherein the pharmacy customer information includes at least one of a number of remaining refills associated with the corresponding pharmaceutical drug, a date of a scheduled refill, and healthcare provider contact information.

8. A system in accordance with claim 1, the IVR request signal including data associated with a video image of a printed prescription drug label captured by a video camera of the mobile computing device, the printed prescription drug label including a unique IVR identifier, the drug ID being associated with the unique IVR identifier.

9. A system in accordance with claim 8, wherein the printed prescription drug label include a digital watermark displayed on the printed prescription drug label and including the unique IVR identifier.

10. A method comprising:
receiving an IVR request signal from a mobile computing device indicating a request to initiate an IVR operation, the IVR request signal including a drug ID;
accessing a database including a list of drug information data records, each drug information data record associated with a corresponding pharmaceutical drug and including a unique drug ID and corresponding drug information associated with a corresponding pharmaceutical drug;
selecting a drug information data record associated with the received drug ID;
retrieving drug information included in the selected drug information data record and generate an IVR audio file including the corresponding drug information;
transmitting an IVR operation data signal to the mobile computing device including the IVR audio file; and
initiating an IVR program application being stored on the mobile computing device to cause the mobile computing device to broadcast an audio presentation of the corresponding drug information to a user via the mobile computing device.

11. A method in accordance with claim 10, wherein the IVR audio file includes pharmacy customer information associated with a pharmacy customer.

12. A method in accordance with claim 10, wherein the IVR request signal includes a customer ID, the method further comprises:
accessing a list of user pharmacy account records being stored in the database, each user pharmacy account record associated with a pharmacy customer and including corresponding pharmacy customer information and a corresponding unique customer ID;
selecting a user pharmacy account record as a function of the received customer ID; and
generating the IVR audio file including pharmacy customer information included in the selected user pharmacy account record.

13. A method in accordance with claim 12, wherein the selected user pharmacy account record includes a plurality of drug IDs associated with a plurality of prescription pharmaceutical drugs associated with the corresponding pharmacy customer, the method further comprises generating a plurality of IVR audio files for use by the IVR program application being executed on the mobile computing device, each IVR audio file being associated with a corresponding prescription pharmaceutical drug.

14. A method in accordance with claim 13, further comprising executing the IVR program application to operate the mobile computing device to receive verbal input from the user to cause the mobile computing device to broadcast audio presentations of each of the plurality of IVR audio files.

15. A method in accordance with claim 12, wherein the IVR request signal includes a mobile user ID associated with the mobile computing device, the method further comprising:
determining if the mobile user ID is associated with the selected user pharmacy account records; and
generating the IVR audio file including pharmacy customer information included in the selected user pharmacy account record upon determining that the received mobile user ID is associated with the selected user pharmacy account record.

16. A method in accordance with claim 12, wherein the pharmacy customer information includes at least one of a number of remaining refills associated with the corresponding pharmaceutical drug, a date of a scheduled refill, and healthcare provider contact information.

17. A method in accordance with claim 10, further comprising receiving the IVR request signal including data associated with a video image of a printed prescription drug label captured by a video camera of the mobile computing device, the printed prescription drug label including a unique IVR identifier, the drug ID being associated with the unique IVR identifier.

18. A method in accordance with claim 17, wherein the printed prescription drug label include a digital watermark displayed on the printed prescription drug label and including the unique IVR identifier.

19. One or more non-transitory computer-readable storage media, having computer-executable instructions embodied thereon, wherein when executed by at least one processor, the computer-executable instructions cause the processor to:
receive an IVR request signal from a mobile computing device indicating a request to initiate an IVR operation, the IVR request signal including a drug ID;
access a database including a list of drug information data records, each drug information data record associated with a corresponding pharmaceutical drug and including a unique drug ID and corresponding drug information associated with a corresponding pharmaceutical drug;
select a drug information data record associated with the received drug ID;
retrieve drug information included in the selected drug information data record and generate an IVR audio file including the corresponding drug information;
transmit an IVR operation data signal to the mobile computing device including the IVR audio file; and
initiate an IVR program application being stored on the mobile computing device to cause the mobile computing device to broadcast an audio presentation of the corresponding drug information to a user via the mobile computing device.

20. One or more non-transitory computer-readable storage media in accordance with claim 19, wherein the computer-executable instructions cause the processor to:
receive the IVR request signal including a customer ID;
access a list of user pharmacy account records being stored in the database, each user pharmacy account record associated with a pharmacy customer and including corresponding pharmacy customer information and a corresponding unique customer ID;
select a user pharmacy account record as a function of the received customer ID; and
generate the IVR audio file including pharmacy customer information included in the selected user pharmacy account record.
